(19) United States
(12) Patent Application Publication
(10) Pub. No.: US 2024/0160150 A1
(43) Pub. Date: May 16, 2024

(54) Systems and Methods for High Volume Manufacturing of Waveguides

(71) Applicant: DigiLens Inc., Sunnyvale, CA (US)

(72) Inventors: Jonathan David Waldern, Los Altos Hills, CA (US); Alastair John Grant, San Jose, CA (US); Milan Momcilo Momcilo, Leicester (GB); Ratson Morad, Sunnyvale, CA (US)

(73) Assignee: DigiLens Inc., Sunnyvale, CA (US)

(21) Appl. No.: 18/326,906

(22) Filed: May 31, 2023

Related U.S. Application Data
(63) Continuation of application No. 16/936,198, filed on Jul. 22, 2020, now abandoned.
(60) Provisional application No. 62/877,198, filed on Jul. 22, 2019.

(51) Int. Cl. G03H 1/04; G03H 1/02

(52) U.S. Cl. CPC G03H 1/041; G03H 1/0248; G03H 1/0465; G03H 2223/23; G03H 2223/25; G03H 2223/50; G03H 2225/22; G03H 2227/03; G03H 2227/05

(57) ABSTRACT

Systems and methods for recording holographic gratings in accordance with various embodiments of the invention are illustrated. One embodiment includes a holographic recording system including a first movable platform configured to support a first plurality of waveguide cells for exposure, at least one master grating, and at least one laser source configured to provide a set of recording beams by directing light towards the at least one master grating, wherein the first movable platform is translatable in predefined steps along at least one of two orthogonal directions, and wherein at each the predefined step at least one waveguide cell is positioned to be illuminated by at least one recording beam within the set of recording beams.

### CROSS-REFERENCE TO RELATED APPLICATIONS

The current application is a continuation of U.S. patent application Ser. No. 16/936,198 entitled “Systems and Methods for High Volume Manufacturing of Waveguides,” filed Jul. 22, 2020, which claims the benefit of and priority under 35 U.S.C. § 119(e) to U.S. Provisional Patent Application No. 62/877,198 entitled “Systems and Methods for High Volume Manufacturing of Waveguides,” filed Jul. 22, 2019, the disclosures of which are hereby incorporated by reference in their entireties.

### FIELD OF THE INVENTION

The present invention generally relates to processes and apparatuses for recording gratings and, more specifically, for recording holographic volume gratings in waveguide cells.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE INVENTION

Systems and methods for recording holographic gratings in accordance with various embodiments of the invention are illustrated. One embodiment includes a holographic recording system including a first movable platform configured to support a first plurality of waveguide cells for exposure, at least one master grating, and at least one laser source configured to provide a set of recording beams by directing light towards the at least one master grating, wherein the first movable platform is translatable in predefined steps along at least one of two orthogonal directions, and wherein at each the predefined step at least one waveguide cell is positioned to be illuminated by at least one recording beam within the set of recording beams.

In another embodiment, the holographic recording system further includes a second movable platform configured to support a second plurality of waveguide cells for exposure, wherein the second movable platform is translatable in predefined steps along at least one of two orthogonal directions.

In a further embodiment, at least one mirror is disposed along at least one optical path from the at least one laser source to the first movable platform.

In still another embodiment, at least one beamsplitter is disposed along at least one optical path from the at least one laser source to the first movable platform.

In a still further embodiment, the holographic recording system further includes an optical filter for filtering out ambient light.

In yet another embodiment, the holographic recording system further includes

In a yet further embodiment, an index matching layer disposed between the master and the waveguide cell.

In another additional embodiment, the set of recording beams includes at least one zero-order beam and at least one diffracted beam formed by illuminating the at least one master grating.

In a further additional embodiment, each of the at least one waveguide cell is illuminated by three sets of recording beams for forming an input grating, a fold grating, and an output grating.

In another embodiment again, the three sets of recording beams each includes a zero-order beam and a diffracted beam.

In a further embodiment again, at each the predefined step at least two waveguide cells are positioned such that each waveguide cell can be illuminated by at least one recording beam within the set of recording beams.

A still yet another embodiment includes a method for recording holographic gratings, the method including providing at least one laser source, forming a set of recording beams by directing light in a first optical path from the at least one laser source towards at least one master grating, providing a first movable platform configured to support a first plurality of waveguide cells, translating the first movable platform to a first operational state so that a first set of waveguide cells within the first plurality of waveguide cells is in position to be illuminated by at least one recording beam from the set of recording beams, exposing the first set of waveguide cells with the at least one recording beam, translating the first movable platform so that a second set of waveguide cells within the first plurality of waveguide cells is in position to be illuminated by with the at least one recording beam, and exposing the second set of waveguide cells with the at least one recording beam.

In a still yet further embodiment, exposing the first set of waveguide cells includes forming a multiplexed grating.

In still another additional embodiment, at least one mirror is disposed along the first optical path.

In a still further additional embodiment, at least one beamsplitter is disposed along the first optical path.

In still another embodiment again, the at least one laser source and the first movable platform is enclosed by an optical filter for filtering out ambient light.

In a still further embodiment again, an index matching layer is disposed between a master grating and at least one waveguide cell within the first plurality of waveguide cells.

In yet another additional embodiment, the set of recording beams includes at least one zero-order beam and at least one diffracted beam formed by illuminating the at least one master grating.

In a yet further additional embodiment, exposing the first set of waveguide cells includes simultaneously forming an input grating, a fold grating, and an output grating within each waveguide cell of the first set of waveguide cells.

In yet another embodiment again, each of the input, fold, and output gratings are formed using a single-beam interference exposure process.

In a yet further embodiment again, the first set of waveguide cells includes at least two waveguide cells.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a single-beam recording process in accordance with an embodiment of the invention

FIGS. 2A and 2B conceptually illustrate HPDLC SBG devices and the switching property of SBGs in accordance with various embodiments of the invention.

FIGS. 3 and 4 conceptually illustrate a holographic recording system for recording multiple waveguide cells disposed in exposure stations in accordance with an embodiment of the invention.

FIGS. 5A and 5B conceptually illustrates a holographic recording system for recording multiple waveguide cells disposed on a single platform in accordance with an embodiment of the invention.

FIGS. 6A-6C conceptually illustrate a step-and-repeat process for exposing batches of three waveguide cells in accordance with an embodiment of the invention.

FIGS. 7A-7C conceptually illustrates a holographic recording system for recording multiple waveguide cells disposed on two platforms in accordance with an embodiment of the invention.

FIGS. 8A-8I show plan views of various operation states of a holographic recording system for recording multiple waveguide cells disposed on two platforms in accordance with an embodiment of the invention.

FIG. 9 is a flow diagram conceptually illustrating a method of recording holographic gratings using a step-and-repeat process in accordance with an embodiment of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

Turning now to the drawings, systems and methods for high volume manufacturing of waveguides in accordance with various embodiments of the invention are illustrated. Recording holographic gratings in waveguides can be utilized in a variety of different applications. As many of these applications are directed at consumer products, recording systems in accordance with various embodiments of the invention can be configured to provide an efficient, low cost means for manufacturing holographic waveguides in large volumes. A system for recording optical elements, such as but not limited to volume gratings, in an optical recording medium can be implemented in many different ways. In many embodiments, the recording system is configured to record a volume grating in an optical recording medium of a waveguide cell. In further embodiments, the volume grating is recorded by exposing the recording medium to an interference pattern formed using at least one laser source. Simultaneous exposure of multiple areas of the waveguide cell(s) can allow for the recording of a plurality of volume gratings—i.e., the plurality of volume gratings can be recorded in one waveguide cell or across multiple waveguide cells. In several embodiments, the exposure mechanism is performed on an exposure stack, which can include at least one waveguide cell and at least one master grating. The use of a master grating can allow for the recording of a grating that is a copy or that is correlated to the master grating.

Recording systems for high volume manufacturing can include the use of movable platform(s) to allow for the recording of multiple waveguide cells using one laser source. Depending on the specific requirements of the given application, the system can utilize more than one laser source. In many embodiments, the recording system includes a plurality of exposure stacks and at least one laser source. Beam expansion and steering optics can be used to form exposure beams directed at the exposure stacks. In some embodiments, a movable platform is implemented to move steering optics or the exposure stack(s) to allow for stepwise exposures of multiple exposure stacks. In further embodiments, more than one movable platform is implemented to allow both the steering optics and the exposure stacks to move. In several embodiments, any of the holographic recording apparatuses described above can further include an optical filter for filtering out ambient light. Such systems, other configurations, grating architectures, waveguide cells, and exposure stacks are discussed in the sections below in further detail.

### Optical Waveguide and Grating Structures

Optical structures recorded in waveguides can include many different types of optical elements, such as but not limited to diffraction gratings. Gratings can be implemented to perform various optical functions, including but not limited to coupling light, directing light, and preventing the transmission of light. The gratings can be surface relief gratings that reside on the outer surface of the waveguide. In other cases, the grating implemented can be a Bragg grating (also referred to as a volume grating), which are structures having a periodic refractive index modulation. Bragg gratings can be fabricated using a variety of different methods. One process includes interferential exposure of holographic photopolymer materials to form periodic structures. Bragg gratings can have high efficiency with little light being diffracted into higher orders. The relative amount of light in the diffracted and zero order can be varied by controlling the refractive index modulation of the grating, a property that can be used to make lossy waveguide gratings for extracting light over a large pupil.

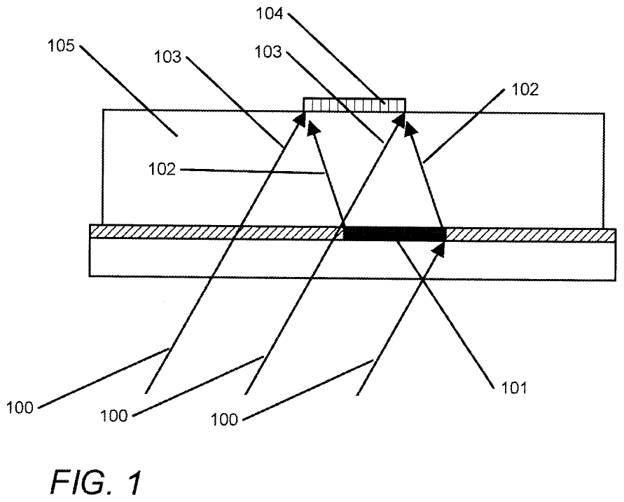

A single-beam recording process utilizing a master grating in accordance with an embodiment of the invention is conceptually illustrated in FIG. 1. As shown, a beam 100 from a single laser source (not shown) is directed through a master grating 101. Upon interaction with the grating 101, the beam 100 can diffract as, for example, in the case of the rays interacting with the black shaded region of the master grating 101, or the beam 100 can propagated through the master grating 101 without substantial deviation as a zero-order beam as, for example, in the case of the rays interacting with the cross-hatched region of the master grating 101. The first order diffraction beams 102 and the zero order beams 103 can overlap to create an interference pattern that exposes the optical recording layer 104 of a waveguide cell. In the illustrative embodiment, a spacer block 105 is positioned between the grating 101 and the optical recording layer 104 in order to alter the distance between the two components.

One class of Bragg gratings used in holographic waveguide devices is the Switchable Bragg Grating (SBG). SBGs can be fabricated by first placing a thin film of a mixture of photopolymerizable monomers and liquid crystal material between substrates. The substrates can be made of various types of materials, such glass and plastics. In many cases, the substrates are in a parallel configuration. The substrates can also form a wedge shape. One or both substrates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many cases, HPDLC material is used. During the recording process, the monomers polymerize, and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. The electrodes are fabricated from indium tin oxide (ITO) or other transparent conductive oxides (TCO). In some cases, index-matched ITO (IMITO) is used. In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance with the multiplicity of selectively switchable grating elements.

Typically, the SBG elements are switched clear in 30 μs with a longer relaxation time to switch ON. The diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The substrates used to form the HPDLC cell provide a total internal reflection (TIR) light guiding structure. Light can be coupled out of the SBG when the switchable grating diffracts the light at an angle beyond the TIR condition.

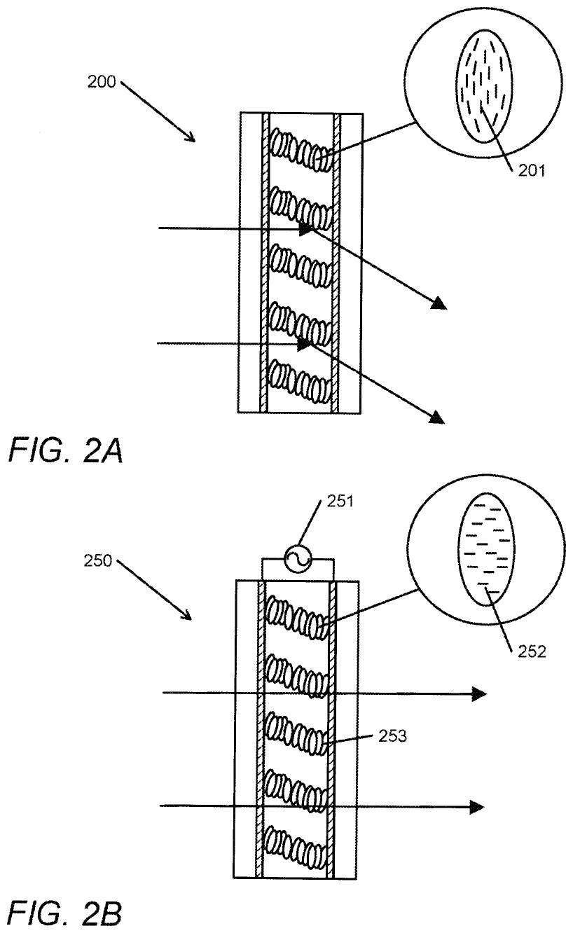

FIGS. 2A and 2B conceptually illustrate HPDLC SBG devices 200, 250 and the switching property of SBGs in accordance with various embodiments of the invention. In FIG. 2A, the SBG 200 is in an OFF state. As shown, the LC molecules 201 are aligned substantially normal to the fringe planes. As such, the SBG 200 exhibits high diffraction efficiency, and incident light can easily be diffracted. FIG. 2B illustrates the SBG 250 in an ON position. An applied voltage 251 can orient the optical axis of the LC molecules 252 within the droplets 253 to produce an effective refractive index that matches the polymer's refractive index, essentially creating a transparent cell where incident light is not diffracted. In the illustrative embodiment, an AC voltage source is shown. As can readily be appreciated, various voltage sources can be utilized depending on the specific requirements of a given application.

In some applications, LC can be extracted or evacuated from the SBG to provide an evacuated Bragg grating (EBG). EBGs can be characterized as a surface relief grating (SRG) that has properties very similar to a Bragg grating due to the depth of the SRG structure (which is much greater than that practically achievable using surface etching and other conventional processes commonly used to fabricate SRGs). The LC can be extracted using a variety of different methods, including but not limited to flushing with isopropyl alcohol and solvents. In many cases, one of the transparent substrates of the SBG is removed, and the LC is extracted. The removed substrate can also be replaced. The SRG can be at least partially backfilled with a material of higher or lower refractive index. Such gratings offer scope for tailoring the efficiency, angular/spectral response, polarization, and other properties to suit various waveguide applications.

### Waveguide Cells

A waveguide cell can be defined as a device containing uncured and/or unexposed optical recording material in which optical elements, such as but not limited to gratings, can be recorded. In many embodiments, optical elements can be recorded in the waveguide cell by exposing the optical recording material to certain wavelengths of electromagnetic radiation. Typically, a waveguide cell is constructed such that the optical recording material is sandwiched between two substrates, creating a three-layer waveguide cell. Depending on the application, waveguide cells can be constructed in a variety of configurations. In many embodiments, the waveguide cell is constructed by vacuum filling an empty waveguide cell made of two substrates. Other filling methods can also be used. In several embodiments, the waveguide cell is constructed by depositing the optical recording material onto one substrate and laminating the composite along with a second substrate to form a three-layer laminate. Various deposition techniques, such as but not limited to spin-coating and inkjet printing, can be used. In some embodiments, the waveguide cell contains more than three layers. In a number of embodiments, the waveguide cell contains different types of layers that can serve various purposes. For example, waveguide cells can include protective cover layers, polarization control layers, and alignment layers.

Substrates of varying materials and shapes can be used in the construction of waveguide cells. In many embodiments, the substrates are plates made of a transparent material, such as but not limited to glass and plastics. Substrates of different shapes, such as but not limited to rectangular and curvilinear shapes, can be used depending on the application. The thicknesses of the substrates can also vary depending on the application. Oftentimes, the shapes of the substrates can determine the overall shape of the waveguide. In a number of embodiments, the waveguide cell contains two substrates that are of the same shape. In other embodiments, the substrates are of different shapes. As can readily be appreciated, the shapes, dimensions, and materials of the substrates can vary and can depend on the specific requirements of a given application.

In many embodiments, beads, or other particles, are dispersed throughout the optical recording material to help control the thickness of the layer of optical recording material and to help prevent the two substrates from collapsing onto one another. In some embodiments, the waveguide cell is constructed with an optical recording layer sandwiched between two planar substrates. Depending on the type of optical recording material used, thickness control can be difficult to achieve due to the viscosity of some optical recording materials and the lack of a bounding perimeter for the optical recording layer. In a number of embodiments, the beads are relatively incompressible solids, which can allow for the construction of waveguide cells with consistent thicknesses. The size of a bead can determine a localized minimum thickness for the area around the individual bead. As such, the dimensions of the beads can be selected to help attain the desired optical recording layer thickness. The beads can be made of any of a variety of materials, including but not limited to glass and plastics. In several embodiments, the material of the beads is selected such that its refractive index does not substantially affect the propagation of light within the waveguide cell.

In some embodiments, the waveguide cell is constructed such that the two substrates are parallel or substantially parallel. In such embodiments, relatively similar sized beads can be dispersed throughout the optical recording material to help attain a uniform thickness throughout the layer. In other embodiments, the waveguide cell has a tapered profile. A tapered waveguide cell can be constructed by dispersing beads of different sizes across the optical recording material. As discussed above, the size of a bead can determine the local minimum thickness of the optical recording material layer. By dispersing the beads in a pattern of increasing size across the material layer, a tapered layer of optical recording material can be formed when the material is sandwiched between two substrates.

### Modulation of Material Composition

High luminance and excellent color fidelity are important factors in AR waveguide displays. In each case, high uniformity across the FOV can be desired. However, the fundamental optics of waveguides can lead to non-uniformities due to gaps or overlaps of beams bouncing down the waveguide. Further non-uniformities may arise from imperfections in the gratings and non-planarity of the waveguide substrates. In SBGs, there can exist a further issue of polarization rotation by birefringent gratings. In applicable cases, the biggest challenge is usually the fold grating where there are millions of light paths resulting from multiple intersections of the beam with the grating fringes. Careful management of grating properties, particularly the refractive index modulation, can be utilized to overcome non-uniformity.

Out of the multitude of possible beam interactions (diffraction or zero order transmission), only a subset contributes to the signal presented at the eye box. By reverse tracing from the eyebox, fold regions contributing to a given field point can be pinpointed. The precise correction to the modulation that is needed to send more into the dark regions of the output illumination can then be calculated. Having brought the output illumination uniformity for one color back on target, the procedure can be repeated for other colors. Once the index modulation pattern has been established, the design can be exported to the deposition mechanism, with each target index modulation translating to a unique deposition setting for each spatial resolution cell on the substrate to be coated/deposited. The resolution of the deposition mechanism can depend on the technical limitations of the system utilized. In many embodiments, the spatial pattern can be implemented to 30 micrometers resolution with full repeatability.

Compared with waveguides utilizing surface relief gratings (SRGs), SBG waveguides implementing manufacturing techniques in accordance with various embodiments of the invention can allow for the grating design parameters that impact efficiency and uniformity, such as but not limited to refractive index modulation and grating thickness, to be adjusted dynamically during the deposition process without the need for a different master. With SRGs where modulation is controlled by etch depth, such schemes would not be practical as each variation of the grating would entail repeating the complex and expensive tooling process. Additionally, achieving the required etch depth precision and resist imaging complexity can be very difficult.

Deposition processes in accordance with various embodiments of the invention can provide for the adjustment of grating design parameters by controlling the type of material that is to be deposited. Various embodiments of the invention can be configured to deposit different materials, or different material compositions, in different areas on the substrate. For example, deposition processes can be configured to deposit HPDLC material onto an area of a substrate that is meant to be a grating region and to deposit monomer onto an area of the substrate that is meant to be a non-grating region. In several embodiments, the deposition process is configured to deposit a layer of optical recording material that varies spatially in component composition, allowing for the modulation of various aspects of the deposited material. The deposition of material with different compositions can be implemented in several different ways. In many embodiments, more than one deposition head can be utilized to deposit different materials and mixtures. Each deposition head can be coupled to a different material/mixture reservoir. Such implementations can be used for a variety of applications. For example, different materials can be deposited for grating and non-grating areas of a waveguide cell. In some embodiments, HPDLC material is deposited onto the grating regions while only monomer is deposited onto the non-grating regions. In several embodiments, the deposition mechanism can be configured to deposit mixtures with different component compositions.

In some embodiments, spraying nozzles can be implemented to deposit multiple types of materials onto a single substrate. In waveguide applications, the spraying nozzles can be used to deposit different materials for grating and non-grating areas of the waveguide. In many embodiments, the spraying mechanism is configured for printing gratings in which at least one the material composition, birefringence, and/or thickness can be controlled using a deposition apparatus having at least two selectable spray heads. In some embodiments, the manufacturing system provides an apparatus for depositing grating recording material optimized for the control of laser banding. In several embodiments, the manufacturing system provides an apparatus for depositing grating recording material optimized for the control of polarization non-uniformity. In several embodiments, the manufacturing system provides an apparatus for depositing grating recording material optimized for the control of polarization non-uniformity in association with an alignment control layer. In a number of embodiments, the deposition workcell can be configured for the deposition of additional layers such as beam splitting coatings and environmental protection layers. Inkjet print heads can also be implemented to print different materials in different regions of the substrate.

As discussed above, deposition processes can be configured to deposit optical recording material that varies spatially in component composition. Modulation of material composition can be implemented in many different ways. In a number of embodiments, an inkjet print head can be configured to modulate material composition by utilizing the various inkjet nozzles within the print head. By altering the composition on a “dot-by-dot” basis, the layer of optical recording material can be deposited such that it has a varying composition across the planar surface of the layer. Such a system can be implemented using a variety of apparatuses including but not limited to inkjet print heads. Similar to how color systems use a palette of only a few colors to produce a spectrum of millions of discrete color values, such as the CMYK system in printers or the additive RGB system in display applications, inkjet print heads in accordance with various embodiments of the invention can be configured to print optical recording materials with varying compositions using only a few reservoirs of different materials. Different types of inkjet print heads can have different precision levels and can print with different resolutions. In many embodiments, a 300 DPI (“dots per inch”) inkjet print head is utilized. Depending on the precision level, discretization of varying compositions of a given number of materials can be determined across a given area. For example, given two types of materials to be printed and an inkjet print head with a precision level of 300 DPI, there are 90,001 possible discrete values of composition ratios of the two types of materials across a square inch for a given volume of printed material if each dot location can contain either one of the two types of materials. In some embodiments, each dot location can contain either one of the two types of materials or both materials. In several embodiments, more than one inkjet print head is configured to print a layer of optical recording material with a spatially varying composition. Although the printing of dots in a two-material application is essentially a binary system, averaging the printed dots across an area can allow for discretization of a sliding scale of ratios of the two materials to be printed. For example, the amount of discrete levels of possible concentrations/ratios across a unit square is given by how many dot locations can be printed within the unit square. As such, there can be a range of different concentration combinations, ranging from 100% of the first material to 100% of the second material. As can readily be appreciated, the concepts are applicable to real units and can be determined by the precision level of the inkjet print head. Although specific examples of modulating the material composition of the printed layer are discussed, the concept of modulating material composition using inkjet print heads can be expanded to use more than two different material reservoirs and can vary in precision levels, which largely depends on the types of print heads used.

Varying the composition of the material printed can be advantageous for several reasons. For example, in many embodiments, varying the composition of the material during deposition can allow for the formation of a waveguide with gratings that have spatially varying diffraction efficiencies across different areas of the gratings. In embodiments utilizing HPDLC mixtures, this can be achieved by modulating the relative concentration of liquid crystals in the HPDLC mixture during the printing process, which creates compositions that can produce gratings with varying diffraction efficiencies when the material is exposed. In several embodiments, a first HPDLC mixture with a certain concentration of liquid crystals and a second HPDLC mixture that is liquid crystal-free are used as the printing palette in an inkjet print head for modulating the diffraction efficiencies of gratings that can be formed in the printed material. In such embodiments, discretization can be determined based on the precision of the inkjet print head. A discrete level can be given by the concentration/ratio of the materials printed across a certain area. In this example, the discrete levels range from no liquid crystal to the maximum concentration of liquid crystals in the first PDLC mixture.

The ability to vary the diffraction efficiency across a waveguide can be used for various purposes. A waveguide is typically designed to guide light internally by reflecting the light many times between the two planar surfaces of the waveguide. These multiple reflections can allow for the light path to interact with a grating multiple times. In many embodiments, a layer of material can be printed with varying composition of materials such that the gratings formed have spatially varying diffraction efficiencies to compensate for the loss of light during interactions with the gratings to allow for a uniform output intensity. For example, in some waveguide applications, an output grating is configured to provide exit pupil expansion in one direction while also coupling light out of the waveguide. The output grating can be designed such that when light within the waveguide interact with the grating, only a percentage of the light is refracted out of the waveguide. The remaining portion continues in the same light path, which remains within TIR and continues to be reflected within the waveguide. Upon a second interaction with the same output grating again, another portion of light is refracted out of the waveguide. During each refraction, the amount of light still traveling within the waveguide decreases by the amount refracted out of the waveguide. As such, the portions refracted at each interaction gradually decreases in terms of total intensity. By varying the diffraction efficiency of the grating such that it increases with propagation distance, the decrease in output intensity along each interaction can be compensated, allowing for a uniform output intensity.

Varying the diffraction efficiency can also be used to compensate for other attenuation of light within a waveguide. All objects have a degree of reflection and absorption. Light trapped in TIR within a waveguide are continually reflected between the two surfaces of the waveguide. Depending on the material that makes up the surfaces, portions of light can be absorbed by the material during each interaction. In many cases, this attenuation is small, but can be substantial across a large area where many reflections occur. In many embodiments, a waveguide cell can be printed with varying compositions such that the gratings formed from the optical recording material layer have varying diffraction efficiencies to compensate for the absorption of light from the substrates. Depending on the substrates, certain wavelengths can be more prone to absorption by the substrates. In a multi-layered waveguide design, each layer can be designed to couple in a certain range of wavelengths of light. Accordingly, the light coupled by these individual layers can be absorbed in different amounts by the substrates of the layers. For example, in a number of embodiments, the waveguide is made of a three-layered stack to implement a full color display, where each layer is designed for one of red, green, and blue. In such embodiments, gratings within each of the waveguide layers can be formed to have varying diffraction efficiencies to perform color balance optimization by compensating for color imbalance due to loss of transmission of certain wavelengths of light.

In addition to varying the liquid crystal concentration within the material in order to vary the diffraction efficiency, another technique includes varying the thickness of the waveguide cell. This can be accomplished through the use of spacers. In many embodiments, spacers are dispersed throughout the optical recording material for structural support during the construction of the waveguide cell. In some embodiments, different sizes of spacers are dispersed throughout the optical recording material. The spacers can be dispersed in ascending order of sizes across one direction of the layer of optical recording material. When the waveguide cell is constructed through lamination, the substrates sandwich the optical recording material and, with structural support from the varying sizes of spacers, create a wedge-shaped layer of optical recording material. spacers of varying sizes can be dispersed similar to the modulation process described above. Additionally, modulating spacer sizes can be combined with modulation of material compositions. In several embodiments, reservoirs of HPDLC materials each suspended with spacers of different sizes are used to print a layer of HPDLC material with spacers of varying sizes strategically dispersed to form a wedge-shaped waveguide cell. In a number of embodiments, spacer size modulation is combined with material composition modulation by providing a number of reservoirs equal to the product of the number of different sizes of spacers and the number of different materials used. For example, in one embodiment, the inkjet print head is configured to print varying concentrations of liquid crystal with two different spacer sizes. In such an embodiment, four reservoirs can be prepared: a liquid crystal-free mixture suspension with spacers of a first size, a liquid crystal-free mixture-suspension with spacers of a second size, a liquid crystal-rich mixture-suspension with spacers of a first size, and a liquid crystal-rich mixture-suspension with spacers of a second size. Further discussion regarding material modulation can be found in U.S. application Ser. No. 16/203,071 filed Nov. 18, 2018 entitled “SYSTEMS AND METHODS FOR MANUFACTURING WAVEGUIDE CELLS.” The disclosure of U.S. application Ser. No. 16/203,491 is hereby incorporated by reference in its entirety for all purposes.

### Multi-Layered Waveguide Fabrication

Waveguide manufacturing in accordance with various embodiments of the invention can be implemented for the fabrication of multi-layered waveguides. Multi-layered waveguides refer to a class of waveguides that utilizes two or more layers having gratings or other optical structures. Although the discussions below may pertain to gratings, any type of holographic optical structure can be implemented and substituted as appropriate. Multi-layered waveguides can be implemented for various purposes, including but not limited to improving spectral and/or angular bandwidths. Traditionally, multi-layered waveguides are formed by stacking and aligning waveguides having a single grating layer. In such cases, each grating layer is typically bounded by a pair of transparent substrates. To maintain the desired total internal reflection characteristics, the waveguides are usually stacked using spacers to form air gaps between the individual waveguides.

In contrast to traditional stacked waveguides, many embodiments of the invention are directed to the manufacturing of multi-layered waveguides having alternating substrate layers and grating layers. Such waveguides can be fabricated with an iterative process capable of sequentially forming grating layers for a single waveguide. In several embodiments, the multi-layered waveguide is fabricated with two grating layers. In a number of embodiments, the multi-layered waveguide is fabricated with three grating layers. Any number of grating layers can be formed, limited by the tools utilized and/or waveguide design. Compared to traditional multi-layered waveguides, this allows for a reduction in thickness, materials, and costs as fewer substrates are needed. Furthermore, the manufacturing process for such waveguides allow for a higher yield in production due to simplified alignment and substrate matching requirements.

Manufacturing processes for multi-layered waveguides having alternating transparent substrate layers and grating layers in accordance with various embodiments of the invention can be implemented using a variety of techniques. In many embodiments, the manufacturing process includes depositing a first layer of optical recording material onto a first transparent substrate. Optical recording material can include various materials and mixtures, including but not limited to HPDLC mixtures and any of the material formulations discussed in the sections above. Similarly, any of a variety of deposition techniques, such as but not limited to spraying, spin coating, inkjet printing, and any of the techniques described in the sections above, can be utilized. Transparent substrates of various shapes, thicknesses, and materials can be utilized. Transparent substrates can include but are not limited to glass substrates and plastic substrates. Depending on the application, the transparent substrates can be coated with different types of films for various purposes. Once the deposition process is completed, a second transparent substrate can then be placed onto the deposited first layer of optical recording material. In some embodiments, the process includes a lamination step to form the three-layer composite into a desired height/thickness. An exposure process can be implemented to form a set of gratings within the first layer of optical recording material. Exposure processes, such as but not limited to single-beam interferential exposure and any of the other exposure processes described in the sections above, can be utilized. In essence, a single-layered waveguide is now formed. The process can then repeat to add on additional layers to the waveguide. In several embodiments, a second layer of optical recording material is deposited onto the second transparent substrate. A third transparent substrate can be placed onto the second layer of optical recording material. Similar to the previous steps, the composite can be laminated to a desired height/thickness. A second exposure process can then be performed to form a set of gratings within the second layer of optical recording material. The result is a waveguide having two grating layers. As can readily be appreciated, the process can continue iteratively to add additional layers. The additional optical recording layers can be added onto either side of the current laminate. For instance, a third layer of optical recording material can be deposited onto the outer surface of either the first transparent substrate or the third transparent substrate.

In many embodiments, the manufacturing process includes one or more post processing steps. Post processing steps such as but not limited to planarization, cleaning, application of protective coats, thermal annealing, alignment of LC directors to achieve a desired birefringence state, extraction of LC from recorded SBGs and refilling with another material, etc. can be carried out at any stage of the manufacturing process. Some processes such as but not limited to waveguide dicing (where multiple elements are being produced), edge finishing, AR coating deposition, final protective coating application, etc. are typically carried out at the end of the manufacturing process.

In many embodiments, spacers, such as but not limited to beads and other particles, are dispersed throughout the optical recording material to help control and maintain the thickness of the layer of optical recording material. The spacers can also help prevent the two substrates from collapsing onto one another. In some embodiments, the waveguide cell is constructed with an optical recording layer sandwiched between two planar substrates. Depending on the type of optical recording material used, thickness control can be difficult to achieve due to the viscosity of some optical recording materials and the lack of a bounding perimeter for the optical recording layer. In a number of embodiments, the spacers are relatively incompressible solids, which can allow for the construction of waveguide cells with consistent thicknesses. The spacers can take any suitable geometry, including but not limited to rods and spheres. The size of a spacer can determine a localized minimum thickness for the area around the individual spacer. As such, the dimensions of the spacers can be selected to help attain the desired optical recording layer thickness. The spacers can take any suitable size. In many cases, the sizes of the spacers range from 1 to 30 μm. The spacers can be made of any of a variety of materials, including but not limited to plastics (e.g., divinylbenzene), silica, and conductive materials. In several embodiments, the material of the spacers is selected such that its refractive index does not substantially affect the propagation of light within the waveguide cell.

In many embodiments, the first layer of optical recording material is incorporated between the first and second transparent substrates using vacuum filling methods. In a number of embodiments, the layer of optical recording materials is separated in different sections, which can be filled or deposited as appropriate depending on the specific requirements of a given application. In some embodiments, the manufacturing system is configured to expose the optical recording material from below. In such embodiments, the iterative multi-layered fabrication process can include turning over the current device such that the exposure light is incident on a newly deposited optical recording layer before it is incident on any formed grating layers.

In many embodiments, the exposing process can include temporarily “erasing” or making transparent the previously formed grating layer such that they will not interfere with the recording process of the newly deposited optical recording layer. Temporarily “erased” gratings or other optical structures can behave similar to transparent materials, allowing light to pass through without affecting the ray paths. Methods for recording gratings into layers of optical recording material using such techniques can include fabricating a stack of optical structures in which a first optical recording material layer deposited on a substrate is exposed to form a first set of gratings, which can be temporarily erased so that a second set of gratings can be recorded into a second optical recording material layer using optical recording beams traversing the first optical recording material layer. Although the recording methods are discussed primarily with regards to waveguides with two grating layers, the basic principle can be applied to waveguides with more than two grating layers.

Multi-layered waveguide fabrication processes incorporating steps of temporarily erasing a grating structure can be implemented in various ways. Typically, the first layer is formed using conventional methods. The recording material utilized can include material systems capable of supporting optical structures that can be erased in response to a stimulus. In embodiments in which the optical structure is a holographic grating, the exposure process can utilize a crossed-beam holographic recording apparatus. In a number of embodiments, the optical recording process uses beams provided by a master grating, which may be a Bragg hologram recorded in a photopolymer or an amplitude grating. In some embodiments, the exposure process utilizes a single recording beam in conjunction with a master grating to form an interferential exposure beam. In addition to the processes described, other industrial processes and apparatuses currently used in the field to fabricate holograms can be used.

Once a first set of gratings is recorded, additional material layers can be added similar to the processes described above. During the exposure process of any material layer after the first material layer, an external stimulus can be applied to any previously formed gratings to render them effectively transparent. The effectively transparent grating layers can allow for light to pass through to expose the new material layer. External stimulus/stimuli can include optical, thermal, chemical, mechanical, electrical, and/or magnetic stimuli. In many embodiments, the external stimulus is applied at a strength below a predefined threshold to produce optical noise below a predefined level. The specific predefined threshold can depend on the type of material used to form the gratings. In some embodiments, a sacrificial alignment layer applied to the first material layer can be used to temporarily erase the first set of gratings. In some embodiments, the strength of the external stimulus applied to the first set of gratings is controlled to reduced optical noise in the optical device during normal operation. In several embodiments, the optical recording material further includes an additive for facilitating the process of erasing the gratings, which can include any of the methods described above. In a number of embodiments, a stimulus is applied for the restoration of an erased layer.

The clearing and restoration of a recorded layer described in the process above can be achieved using many different methods. In many embodiments, the first layer is cleared by applying a stimulus continuously during the recording of the second layer. In other embodiments, the stimulus is initially applied, and the grating in the cleared layer can naturally revert to its recorded state over a timescale that allows for the recording of the second grating. In other embodiments, the layer stays cleared after application of an external stimulus and reverts in response to another external stimulus. In several embodiments, the restoration of the first optical structure to its recorded state can be carried out using an alignment layer or an external stimulus. An external stimulus used for such restoration can be any of a variety of different stimuli, including but not limited to the stimulus/stimuli used to clear the optical structure. Depending on the composition material of the optical structure and layer to be cleared, the clearing process can vary. Further discussion regarding the multi-layered waveguide fabrication utilizing external stimuli can be found in U.S. application Ser. No. 16/522,491 filed Jul. 25, 2019 entitled “Systems and Methods for Fabricating a Multilayer Optical Structure.” The disclosure of U.S. application Ser. No. 16/522,491 is hereby incorporated by reference in its entirety for all purposes.

### HPDLC Optical Recording Material Systems

HPDLC mixtures generally include LC, monomers, photoinitiator dyes, and coinitiators. The mixture (often referred to as syrup) frequently also includes a surfactant. For the purposes of describing the invention, a surfactant is defined as any chemical agent that lowers the surface tension of the total liquid mixture. The use of surfactants in PDLC mixtures is known and dates back to the earliest investigations of PDLCs. For example, a paper by R. L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. I 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element having: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s. Many of these materials use acrylate monomers, including:
R. L. Sutherland et al., Chem. Mater. 5, 1533 (1993), the disclosure of which is incorporated herein by reference, describes the use of acrylate polymers and surfactants. Specifically, the recipe comprises a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y. H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T. J. Bunning et al., Polymer Science: Part B: Polymer Physics, Vol. 35, 2825-2833, 1997, the disclosure of which is incorporated herein by reference, also describes multifunctional acrylate monomers.
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.

Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.

Nanoparticle-Based Optical Recording Material Systems

Material systems in accordance with various embodiments of the invention can include photopolymer mixtures capable of forming holographic Bragg gratings. In a number of embodiments, the mixtures are able to form holographic gratings using interferential photolithography. In such cases, the index modulation is created by the varying exposure intensity of the interference pattern. Any of a variety of lithographic techniques, including those described in the sections above and those well-known in the art, can be used. Compared to conventional techniques relying on index changes through photo-reactivity, material systems and techniques in accordance with various embodiments of the invention utilize phase separation processes initiated through interferential exposure. In many embodiments, the photopolymer mixture includes different types of monomers, dyes, photoinitiators, and nanoparticles. Monomers can include but are not limited to vinyls, acrylates, methacrylates, thiols, epoxides, and other reactive groups. In some embodiments, the mixture can include monomers having different refractive indices. In several embodiments, the mixture can include reactive diluents and/or adhesion promoters. As can readily be appreciated, various types of mixtures and compositions can be implemented as appropriate depending on the specific requirements of a given application. In a number of embodiments, the mixture implemented is based on material systems described in U.S. application Ser. No. 16/242,943 entitled “Low Haze Liquid Crystal Materials” filed Jan. 8, 2019, U.S. application Ser. No. 16/242,954 entitled “Liquid Crystal Materials and Formulations” filed Jan. 8, 2019, U.S. application Ser. No. 16/007,932 entitled “Holographic Material Systems and Waveguides Incorporating Low Functionality Monomers” filed Jun. 13, 2018, and U.S. application Ser. No. 16/799,735 entitled “Holographic Polymer Dispersed Liquid Crystal Mixtures with High Diffraction Efficiency and Low Haze” filed Feb. 24, 2020. The disclosures of U.S. application Ser. Nos. 16/242,943, 16/242,954, 16/007,932, and 16/799,735 are hereby incorporated by reference in their entireties for all purposes.

To form holographic gratings, a master grating can be used to direct an exposure beam and to form an interferential pattern onto a layer of uncured photopolymer material to form gratings. As described above, the recording process can be performed on a waveguide cell that includes a layer of uncured photopolymer material sandwiched by two transparent substrates, which are typically made of plastic or glass plates. The waveguide cell with the layer of uncured photopolymer material can be formed in many different ways, including but not limited to vacuum filling and printing deposition processes. By exposing the master grating with a recording beam, a portion of the beam will diffract while a portion passes through as zero-order light. The diffracted portion and the zero-order portion can interfere to expose the photopolymer material. The monomers and nanoparticles phase separated to form alternating regions of monomers and nanoparticles corresponding to the interference pattern, effectively forming a volume Bragg grating. In a number of embodiments, two different exposure beams are utilized to form the interference pattern for the desired exposure.

Depending on the application, the type and size of the formed gratings can differ widely. In several embodiments, the nanoparticle-based photopolymer system is implemented to form isotropic gratings. Isotropic gratings can be advantageous in many different waveguide applications. As described in the sections above, anisotropic gratings, such as those formed from traditional HPDLC material systems, can produce a polarization rotation effect on light propagating within the waveguide, resulting in striations and other undesirable artefacts. Waveguides incorporating isotropic gratings can eliminate many of these artefacts, improving light uniformity. In many embodiments, the nanoparticle-based gratings have high diffraction efficiencies for both S- and P-polarized light, which enable more uniform and efficient waveguides compared to typical HPDLC gratings. In some embodiments, the gratings provide diffraction efficiencies of at least ˜20% for at least one of S- and P-polarized light. In further embodiments, the gratings provide diffraction efficiencies of at least ˜40% for at least one of S- and P-polarized light. As can readily be appreciated, such gratings can be configured with the appropriate polarized response depending on the specific requirements of a given application. For example, in a number of embodiments, the gratings provide at least ˜40% diffraction efficiency for S-polarized light to implement a waveguide display with adequate brightness. In further embodiments, the gratings provide at least ˜40% diffraction efficiency for S-polarized light and at least ˜10% diffraction efficiency for P-polarized light.

Waveguide applications typically utilize subwavelength-sized gratings to enable the desired propagation and control of light within the waveguide. As such, several embodiments of the invention include the use of nanoparticle-based photopolymer material to form gratings having periods of less than ˜500 nm. In further embodiments, the gratings have periods of ˜300-500 nm. In a number of embodiments, the type of monomers and nanoparticles can be selected to provide a high rate of diffusion during the phase separation process of the grating formation. A high rate of diffusion can facilitate and can be required in some applications for the formation of small gratings. In many embodiments, the gratings are formed to have rolled K-vectors—i.e., the K-vectors of the gratings vary while maintaining a similar period. In addition to different periods and varying K-vectors, the gratings can also be formed to have a specific thickness, which is typically defined by the thickness of the layer of photopolymer material. As can readily be appreciated, the thickness at which the gratings are formed can depend on the specific application. In general, thinner gratings result in lower diffraction efficiencies but higher operating angular bandwidth. In contrast to other conventional material systems, photopolymer material systems in accordance with various embodiments of the invention are capable of providing thin gratings with sufficient diffraction efficiency values for many desired waveguide applications. In many embodiments, the gratings are formed to have a thickness of less than ˜5 μm. In further embodiments, the gratings are formed to have a thickness of ˜1-3 μm. In several embodiments, the gratings have a varying thickness profile.

The type of components utilized can depend on the specific requirements of a given application. For example, the type of nanoparticle can be selected to have low reactivity with the remaining components (i.e., the nanoparticles are chosen for their non-reactivity to the monomers, dyes, coinitiators, etc. in the material system). In a number of embodiments, zirconium dioxide nanoparticles are utilized. In many applications, waveguide efficiency is of critical importance. In such cases, a nanoparticle having low-absorptive properties can be advantageous. Given the amount of grating interactions within a typical waveguide application, even absorption values considered low in conventional systems can still result in an unacceptable loss of efficiency. For example, typical metallic nanoparticles having high absorptive properties would likely be undesirable for many waveguide applications. As such, in many embodiments, the type of nanoparticles is selected to provide less than 0.1% absorption. In some embodiments, the nanoparticles are non-metallic. In addition to low absorptive values, other characteristics affecting waveguide performance and grating-formation can also be considered.

As described above, small gratings can be advantageous in many waveguide applications. Compared to traditional HPDLC material systems, phase-separated nanoparticle-based photopolymer material can allow for the formation of gratings with a much higher resolution due to the relatively small size of nanoparticles compared to LC droplets. In typical HPDLC material systems, the LC droplets are about 100 nm in size. This can lead to certain limitations in some applications. For instance, many waveguide applications implement a holographic exposure/recording process for forming gratings within a waveguide. Depending on the application, the resolution of feature sizes of the master grating can be limited. In several embodiments, the master grating has about ˜125 nm resolution. As such, forming gratings using 100 nm LC droplets can be difficult and leaves little margin for error. Contrasted with photopolymer material systems described herein, the nanoparticles that form the gratings are at least an order of magnitude smaller. In some embodiments, the material system includes nanoparticles that have diameters of less than 15 nm. In further embodiments, the nanoparticles have diameters of ˜4-˜10 nm. The relatively small sizes of the nanoparticles in comparison with the resolution of the feature sizes of the master grating allow for the formation of gratings with high fidelity. Furthermore, the physical characteristics of the nanoparticles can allow for the formation of gratings that result in relatively low haze compared to the large liquid crystal droplet sizes of traditional HPDLC material systems. In several embodiments, haze of less than ˜1% can be achieved. In further embodiments, the system has haze of less than ˜0.5%. Another important characteristic to consider in the selection of the type of nanoparticles to be used includes their refractive indices. In many applications, such as waveguide display applications, the refractive indices of the components and materials can have a large effect on waveguide performance and efficiency. For example, the refractive indices of the components within a grating can determine its diffraction efficiency. In some embodiments, nanoparticles having a high refractive index n are utilized to form gratings having high diffraction efficiencies. For example, in a number of embodiments, ZrO₂ nanoparticles having a refractive index of at least 1.7 are utilized. In some embodiments, nanoparticles having refractive indices of at least 1.9 are utilized. In further embodiments, nanoparticles having refractive indices of at least 2.1 are utilized. The nanoparticles and monomers within the photopolymer mixture are chosen to provide gratings having a high Δn. In several embodiments, the gratings have refractive index modulations of at least ˜0.04 Δn. In further embodiments, gratings having refractive index modulations of ˜0.05-0.06 Δn are utilized. Such materials can be advantageous in enabling the formation of thin gratings having sufficient diffraction efficiencies for certain waveguide applications. In a number of embodiments, the materials can form ˜2 μm-thick gratings having diffraction efficiencies of above 30%. In further embodiments, the gratings can have diffraction efficiencies of above 40%. In certain cases, metallic nanoparticles can be implemented to provide a high refractive index, a typically characteristic of metallic components. However, as discussed above, metallic components typically have high absorption and are unsuitable for use in many different waveguide applications. As such, many embodiments of the invention are directed towards material systems having non-metallic nanoparticles that are capable of forming thin, efficient gratings.

### Multiple Waveguide Modules Exposure Systems

Holographic recording systems in accordance with various embodiments of the invention can be configured for exposing a large number of waveguide cells. In many embodiments, the recording system utilizes a laser source and beam expansion and steering optics to expose an exposure stack containing a waveguide cell. In further embodiments, the exposure stack includes a master grating. In such embodiments, the grating to be recorded in the waveguide cell can be a copy or be correlated to the grating in the master grating. Exposure stacks can include various components that are designed to manipulate incoming light from the laser source(s) into the exposure areas of waveguide cells. Exposure areas are designated areas on the waveguide cell where the light is intended to expose. As can readily be appreciated, the sizes and shapes of the exposure areas can vary and can largely depend on the volume gratings that are to be written. For example, in some applications, different types of volume gratings requiring different levels of exposure are recorded in the same waveguide cell. In many embodiments, the recording system is configured to expose each individual exposure area with light of different levels of power and/or duration, which can be specifically tailored to the type of volume grating that is to be recorded. As can readily be appreciated, waveguide cells can have any number of exposure areas of any shapes and sizes in accordance with various embodiments of the invention. The present disclosure can incorporate many of the embodiments and teachings disclosed in U.S. patent application Ser. No. 16/116,834 filed Aug. 29, 2018, entitled “Systems and Methods for High-Throughput Recording of Holographic Waveguides.” The disclosure of U.S. patent application Ser. No. 16/116,834 is hereby incorporated by reference in its entirety for all purposes.

Exposure stacks can be constructed with different combinations of components. In many embodiments, an exposure stack includes a master grating and a waveguide cell. In some embodiments, the master grating is an amplitude grating. In further embodiments, the master grating is a chrome master made up of a transparent layer and a chrome layer that defines a grating structure. During the recording process, light from one or more laser sources can be directed toward the exposure stack using various optical components, such as but not limited to mirrors and beamsplitters. In a single beam recording system, a single light beam is directed toward the master grating in an exposure stack. Upon interaction with the master grating, the light beam can diffract, and the first order diffraction and zero order beam can form an interference pattern that exposes the waveguide cell to form a volume grating.

In several embodiments, the exposure stack includes a protective layer, such as but not limited to a glass plate, that can be placed adjacent to the master grating to help prevent mechanical damage to the gratings. In various embodiments, optical oil can be used between the various layers to help provide continuity of refractive indices.

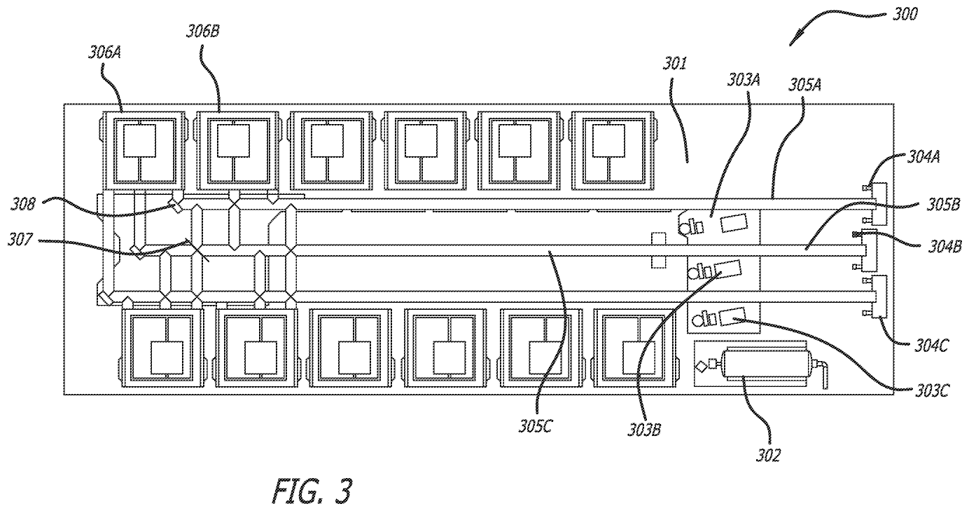

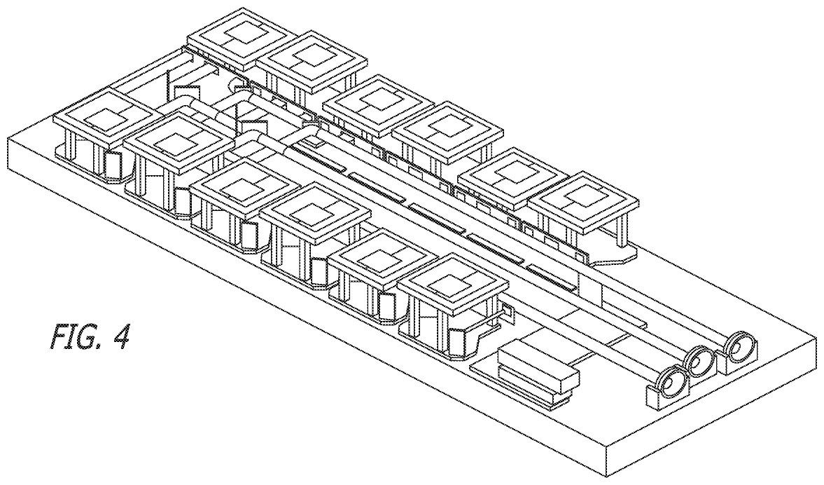

FIGS. 3-4 conceptually illustrate a plan view and an isometric view, respectively, of an apparatus for holographic recording in accordance with an embodiment of the invention. In the illustrative embodiment, the recording apparatus can operate on a multiplicity of modules, or exposure stacks, containing waveguide cells and overlapping master gratings, exposing a subset of the cells at the same time. FIG. 3 conceptually illustrates, in plan view, one such configuration, which operates on twelve modules, exposing four waveguide cells (hence providing a “quad” exposure system) in accordance with one embodiment of the invention. As shown, the apparatus 300 includes a platform 301 supporting a laser disposed on a mount 302 that can further support beam steering optics and a second platform supporting beam expansion and steering optics 303A-303C for providing three exposure beams, which are reflected by mirrors 304A-304C to provide beams 305A-305C for exposure of the waveguide parts. Waveguide exposure modules, including the modules 306A-306D, are disposed along both sides of the platform. During operation, the three exposure beams 305A-305C can be divided and reflected by means of beam splitters 307 and mirrors 308 such that each module receives a portion of the exposure light carried by the beams 305A-305C. Although FIGS. 3-4 illustrate a stage designed to perform successive exposures on groups of four modules at a time, it should be apparent from consideration of FIGS. 3-4 that, in other embodiments, the apparatus can be configured to provide successive exposures to more than four modules at a time. For example, in some embodiments, the apparatus is configured for simultaneous exposures of eight module stations. The general principle can be applied to any number of modules subject to economic and space constraints. In many embodiments, the number of stations may be determined by the exposed waveguide settling time. In several embodiments, the number of stations can be between four and twenty.

### Step-and-Repeat Holographic Recording Systems

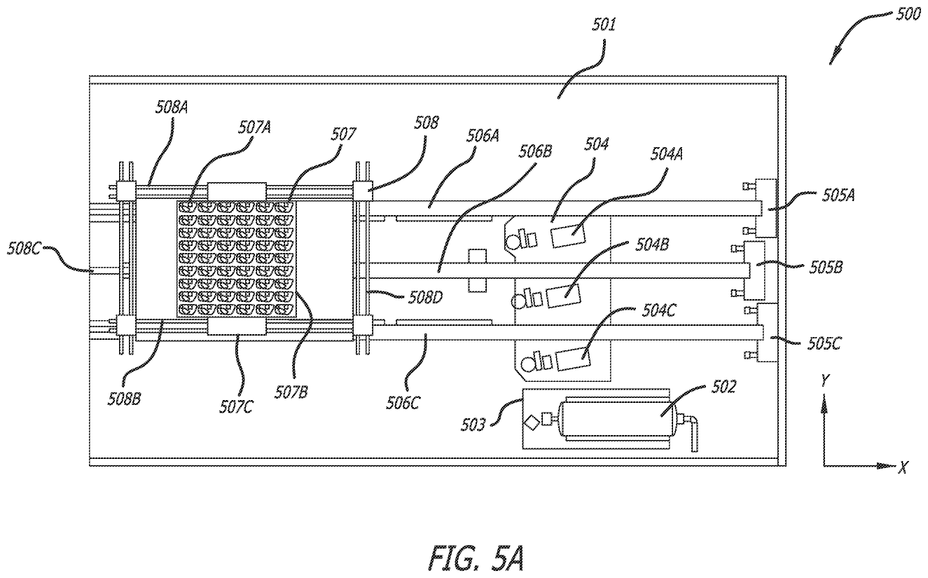

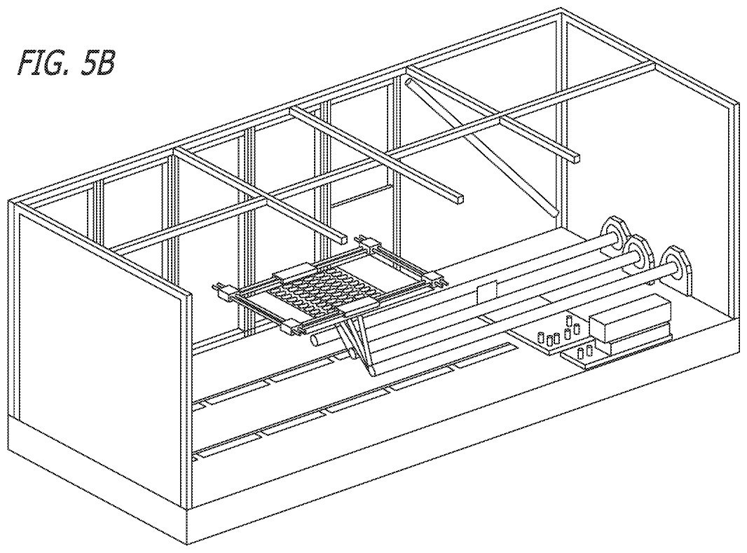

Holographic recording systems for simultaneously exposing multiple waveguide cells can be implemented in many different ways. In addition to configurations utilizing exposure stations, such as those described in the sections above, holographic recording systems can implement a step-and-repeat recording process on a plurality of waveguide cells mounted on a platform. FIG. 5A conceptually illustrates a holographic recording system for recording multiple waveguide cells disposed on a single platform in accordance with an embodiment of the invention. As shown, the apparatus 500 includes a base platform 501 supporting a laser 502 disposed on a second platform 503 that can further support beam expansion and steering optics. The apparatus 500 further includes a third platform 504 supporting beam steering and expansion optics 504A-504C for forming three exposure beams from the laser 502. The three exposure beams can be reflected by mirrors 505A-505C to provide beams 506A-506C for the exposure of the waveguide parts. An array 507 of optical parts or cells 507A for exposure can be disposed on a moveable platform 507B mounted on a further translatable platform 507C, which can traverse along rails 508A,508B mounted on the platform 501. In some configurations, the optical cells 507A include waveguide cells that are disposed above at least one master grating (not shown). During the exposure process, the expose beams are directed towards the master grating(s) to expose the waveguide cells 507A from underneath. In many embodiments, the master gratings and waveguides cells are separated by index matching material such as but not limited to an index-matching oil. Additional rails 508C,508D can be included to enable travel in a second direction. In the illustrative embodiment, the exposure optics is stationary while the array of waveguide cells can be traversed in a stepwise fashion in orthogonal directions (X and Y). As can readily be appreciated, the apparatus 500 can be implemented with an array of any amount of waveguide cells, subject to the sizes of the waveguide cells and the substrate. Additionally, the apparatus 500 can be configured to expose one or more cells simultaneously. In further embodiments, the apparatus 500 is configured to expose the waveguide cells within the array in successive batches (stepwise). In the embodiment of FIG. 5A, fifty-four cells are provided with three cells exposed at a time. In many embodiments, such as the one of FIG. 5A, the waveguide cells can support input, fold, and output gratings. In some embodiments, waveguides cells for use in different products can be exposed on the same substrate. Such embodiments may include additional optics for providing the required exposure beam geometry for each cell type. In several embodiments, the apparatus 500 can be configured to accommodate optics including but not limited to mirrors, beamsplitters, beam shaping optics, filters, apertures etc. FIG. 5B provides an isometric view of the apparatus of FIG. 5A.

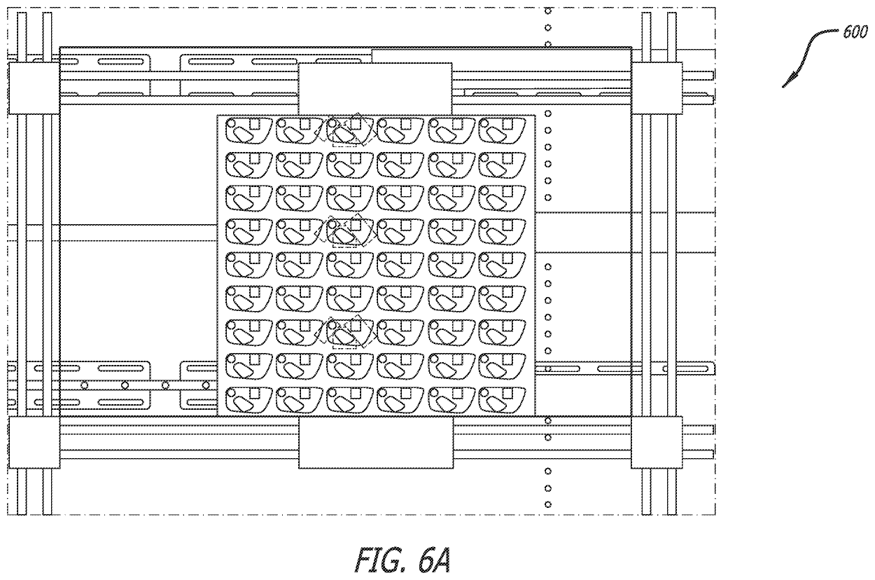

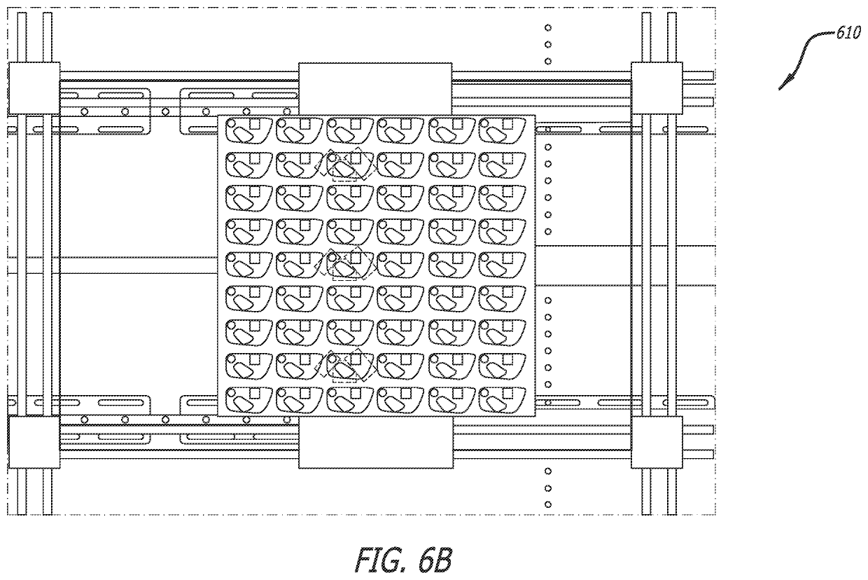

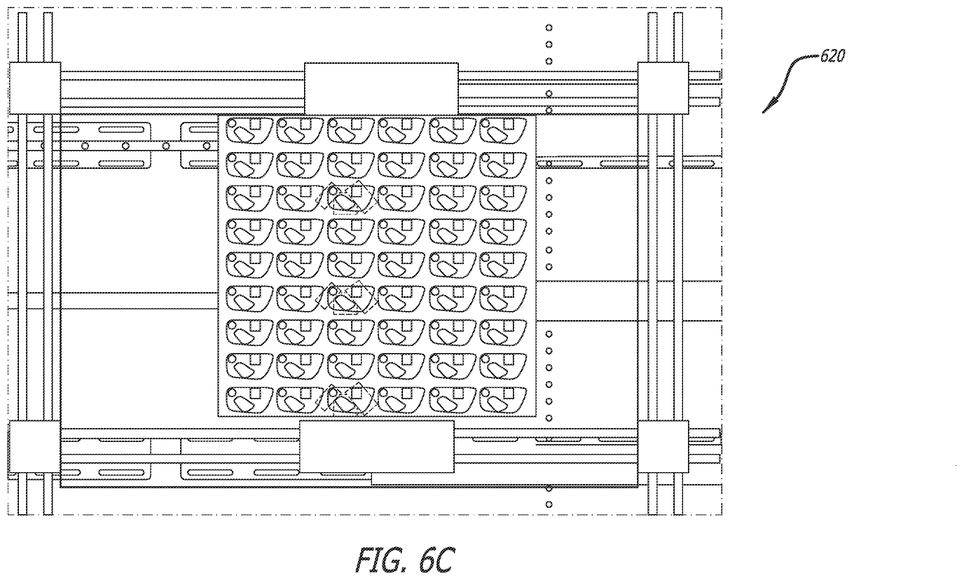

As described above, more than one waveguide cell can be exposed simultaneously. Utilizing a step-and-repeat process, batches of waveguide cells can be exposed serially. A step-and-repeat process for exposing batches of three waveguide cells in accordance with an embodiment of the invention is conceptually illustrated in FIGS. 6A-6C. Three different configurations of the cell array relative to the exposure beam paths with the exposure optical heads superimposed are illustrated schematically. In the illustrative embodiment, three master gratings can be positioned in the paths of the exposure beams, and the platform supporting the waveguide cells can be positioned in different configurations in order to expose different batches of three waveguide cells. FIG. 6A shows a first operational state 600 in which cells addressed by the first, fourth, and seventh cell rows and the third cell column overlap the three exposure optical heads. FIG. 6B shows a second operational state 610 in which cells addressed by the second, fifth and eighth cell rows and the third cell column overlap the three exposure optical heads. FIG. 6C shows a second operational state 620 in which cells addressed by the third, sixth and ninth cell rows and the third cell column overlap the three exposure optical heads.

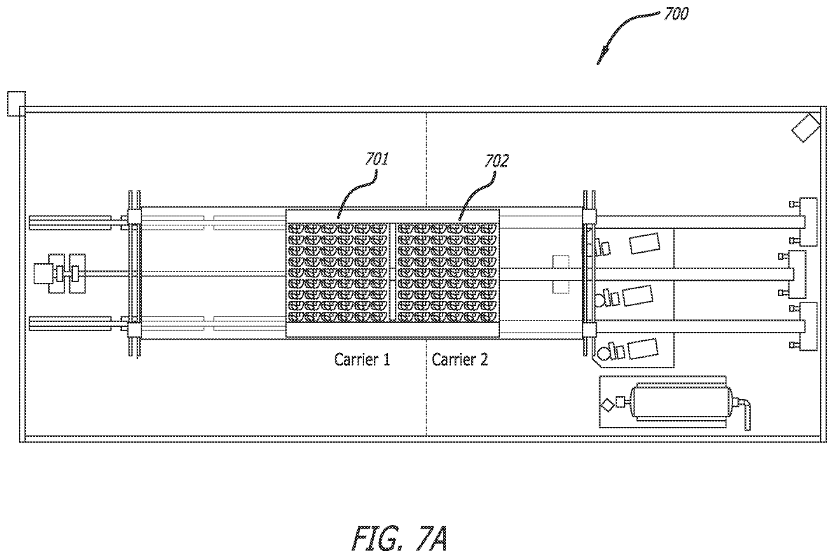

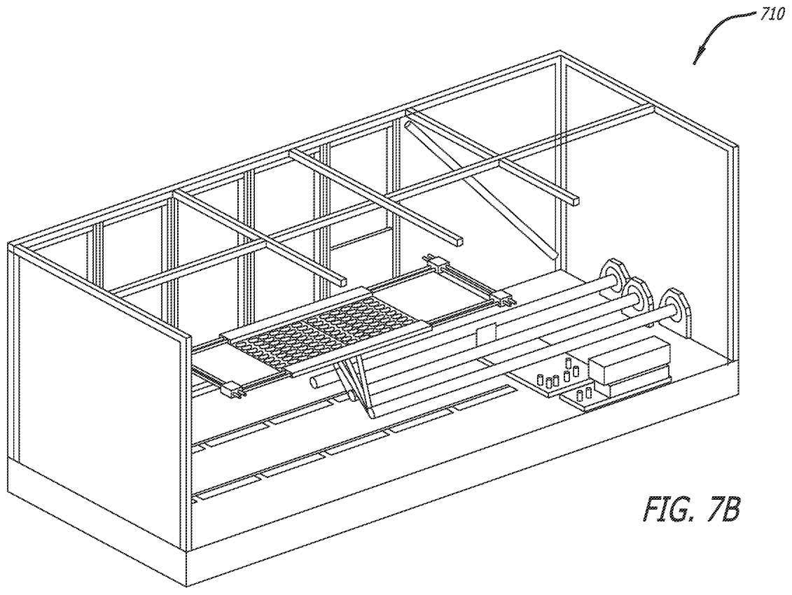

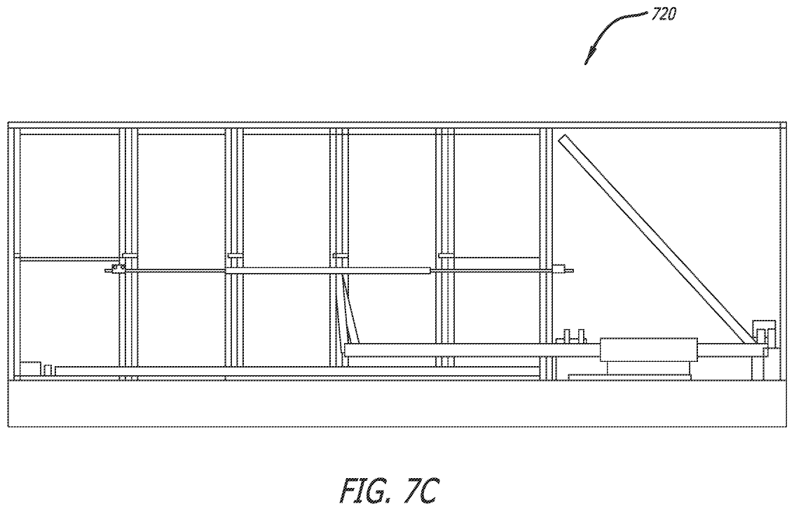

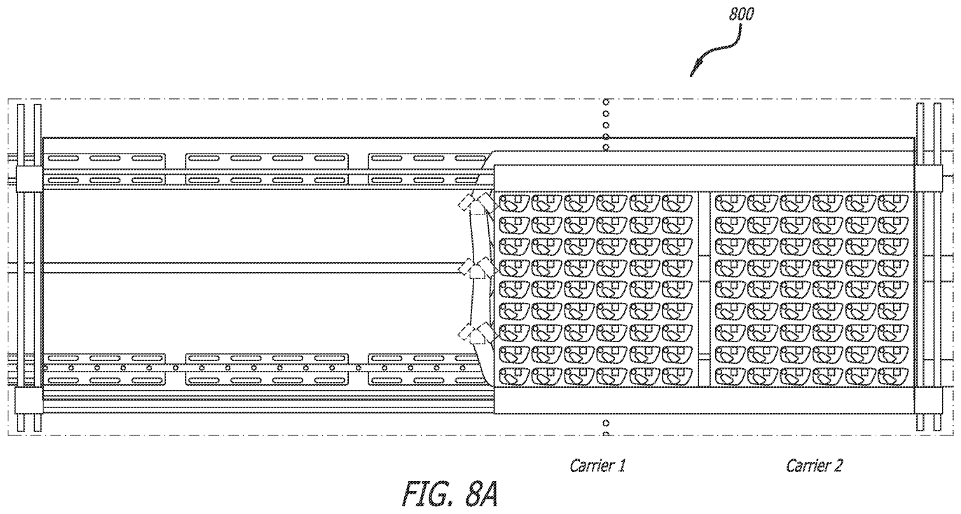

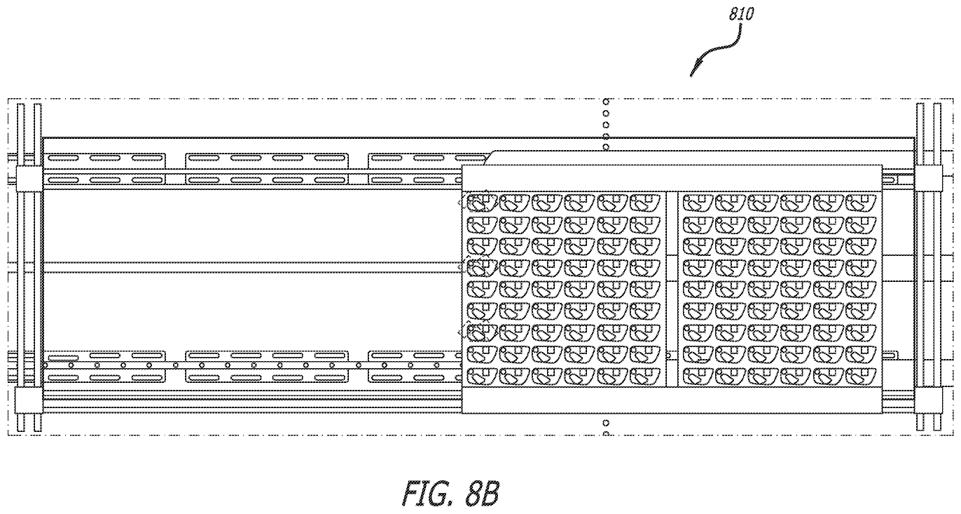

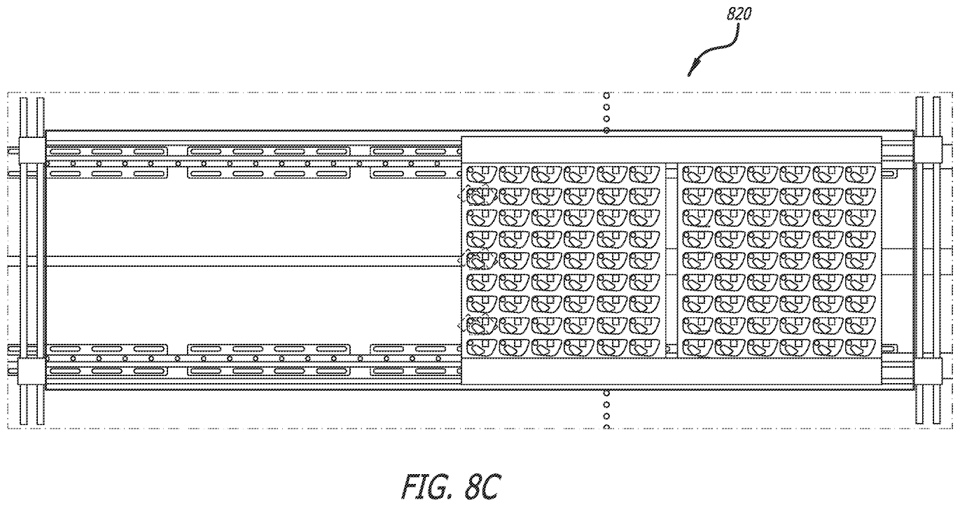

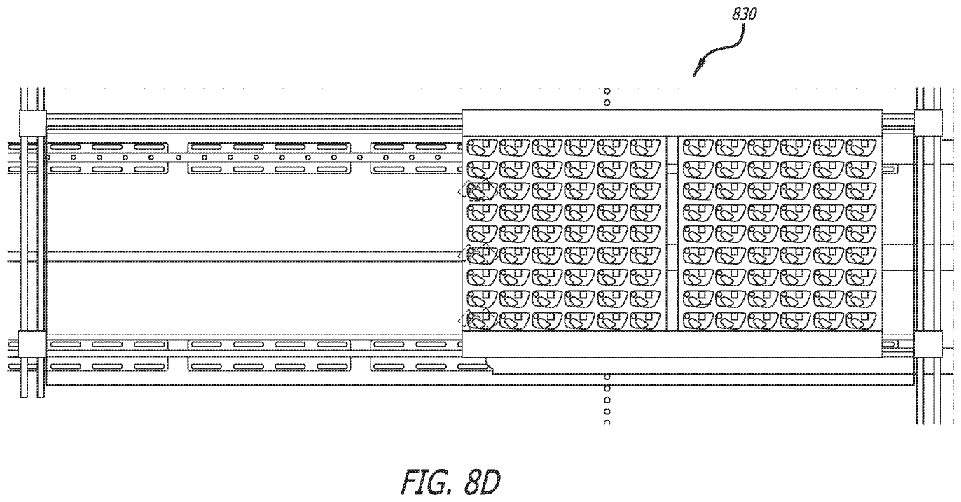

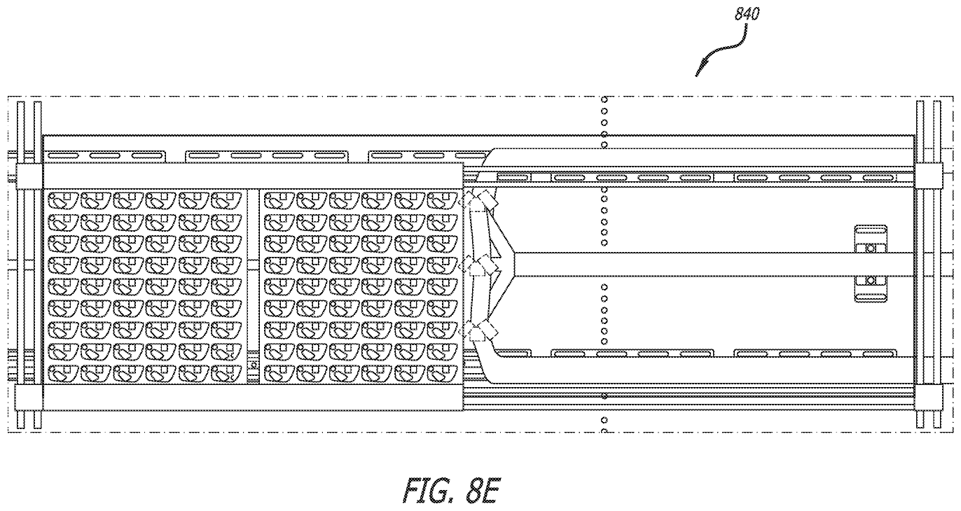

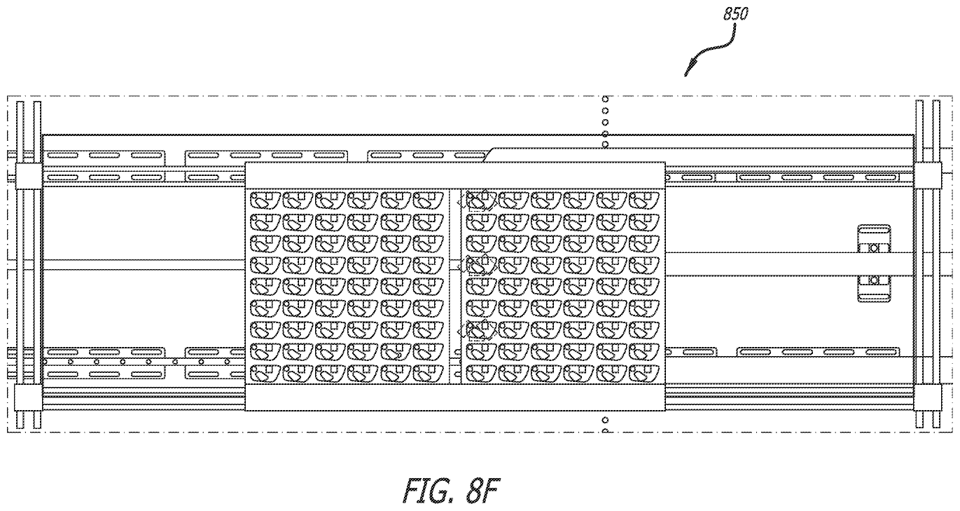

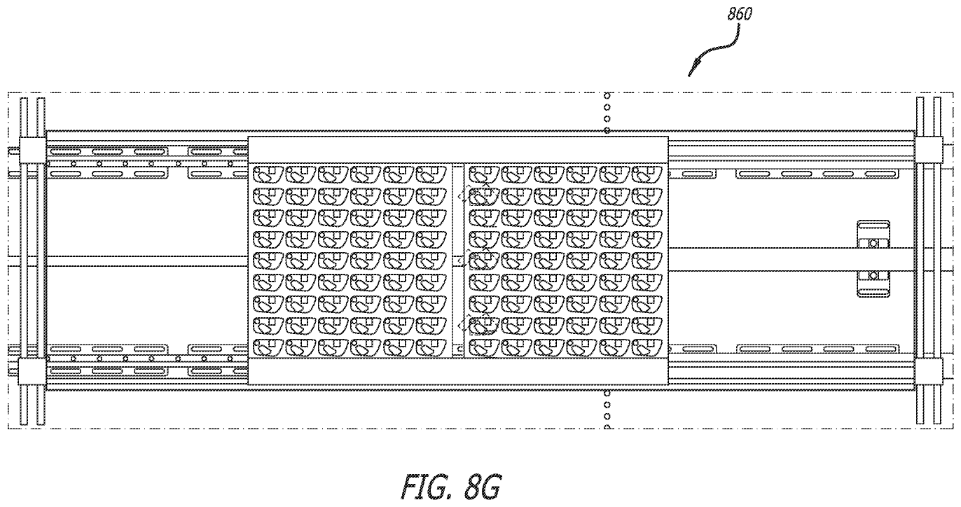

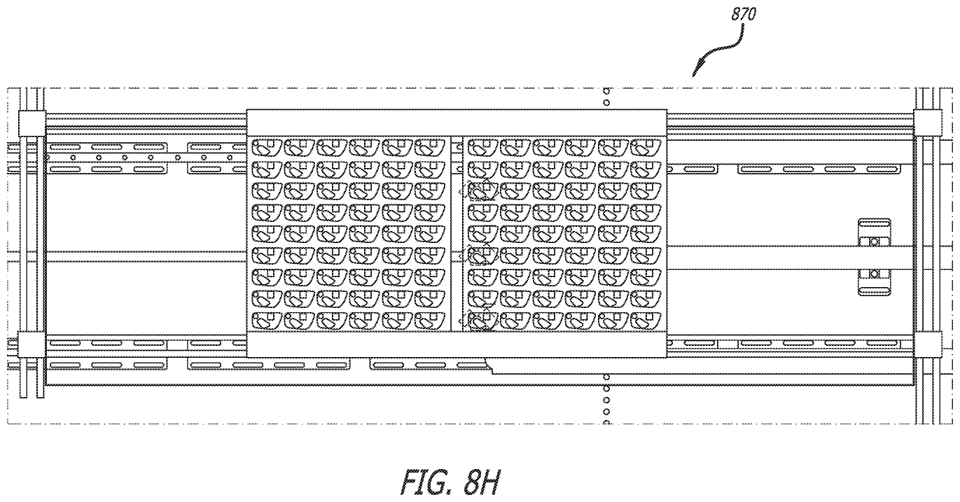

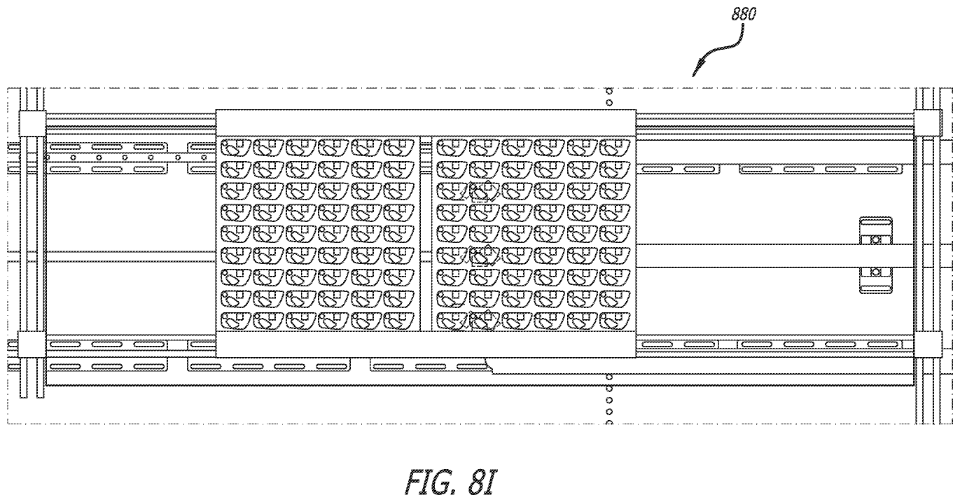

In many embodiments, more than one platform for supporting arrays of cells can be provided. Such embodiments have the advantage that while one array is being exposed, the other(s) is (are) “settling,” that is, the phase separation process used to form the gratings is reaching a stable state. FIG. 7A conceptually illustrates a step and repeat system 700 with two substrates 701,702 (also referred to as carrier 1 and carrier 2), each supporting a different array of waveguide cells, in accordance with an embodiment of the invention. FIGS. 7B and 7C show an isometric view 710 and a side elevation view 720, respectively, of the apparatus 700 of FIG. 7A. FIGS. 8A-8I show plan views of various operation states of the apparatus of FIG. 8A. FIG. 8A conceptually illustrates an operational state 800 in which both carriers are populated with cells (and overlapping master gratings). As shown, the carriers are disposed away from the exposure optical heads, with carrier 1 to the right of the exposure heads. FIG. 8B conceptually illustrates an operational state 810 in which both carriers are populated with cells and the exposure optical heads overlap cells of carrier 1, addressed by the first column and the first, fourth, and seventh rows. In many embodiments, the cells disposed on carrier 2 can be settling while the cells on carrier 1 are being exposed. FIG. 8C conceptually illustrates an operational state 820 in which both carriers are populated with cells and the exposure optical heads overlap cells of carrier 1, addressed by the first column and the second, fifth, and eighth rows. FIG. 8D conceptually illustrates an operational state 830 in which both carriers are populated with cells and the exposure optical heads overlap cells of carrier 1, addressed by the first column and the third, sixth, and ninth rows. FIG. 8E conceptually illustrates an operational state 840 in which both carriers are populated with cells and the carriers disposed away from the exposure optical heads with carrier 2 to the right of the exposure heads. FIG. 8F conceptually illustrates an operational state 850 in which both carriers are populated with cells and the exposure optical heads overlap cells of carrier 2, addressed by the first column and the first, fourth, and seventh rows. In many embodiments, the cells of carrier 1 can be settling while the cells of carrier 2 are being exposed. FIG. 8G conceptually illustrates an operational state 860 in which both carriers are populated with cells and the exposure optical heads overlap cells of carrier 2, addressed by the first column and the second, fifth, and eighth rows. FIG. 8H conceptually illustrates an operational state 870 in which both carriers are populated with cells and the exposure optical heads overlap cells of carrier 2, addressed by the first column and the third, sixth, and ninth rows. FIG. 8I conceptually illustrates an operational state 880 in which both carriers are populated with cells and the exposure optical heads overlap cells of carrier 2, addressed by the second column and the third, sixth, and ninth rows.

Processes for exposing waveguide cells utilizing recording systems, such as those described in FIGS. 5A and 7A, can be implemented in a variety of ways. FIG. 9 is a flow diagram conceptually illustrating a method of recording holographic gratings using a step-and-repeat process in accordance with an embodiment of the invention. As shown, the method 900 includes providing (901) at least one laser source. A set of exposure beams can be formed (902) using the at least one laser source. The exposure beams can be formed from a single laser source using various beam expansion and steering optics. Depending on the application, different numbers and types of exposure beams can be formed. For example, the number of exposure beams formed can depend on the number of gratings to be formed within each waveguide cell and/or the number of waveguide cells to be exposed simultaneously. The number of exposure beams can also depend on the power of the laser source. As can readily be appreciated, more than one laser source can be implemented to expose more waveguide cells simultaneously. At least one master grating and a movable platform supporting a plurality of waveguide cells can be provided (903). Master gratings such as chrome amplitude gratings, volume gratings, and other types of gratings can be utilized. A set of holographic gratings can be formed (904) in a first waveguide cell using an interference pattern formed by illuminating a master grating with at least one exposure beam. Single-beam exposure processes such as those described above can be utilized. The movable platform can be translated (905) such that a second waveguide cell is in an exposure path. A set of holographic gratings can be formed (906) in the second waveguide cell using an interference pattern formed by illuminating the master grating, which can be the same master grating utilized in exposing the first waveguide cell. As described above, step-and-repeat processes can be implemented to simultaneously expose batches of waveguide cells. For example, two waveguide cells can be exposed using two master gratings and two exposure beams. The platform can be translated to move two other waveguide cells into position. The same two master gratings can then be used to form gratings within the two new waveguide cells. As can readily be appreciated, such batch exposures can be performed on batches of more than two waveguide cells.

### Doctrine of Equivalents

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A holographic recording system comprising:
a first movable platform configured to support a first plurality of waveguide cells for exposure;
at least one master grating; and
at least one laser source configured to provide a set of recording beams by directing light towards said at least one master grating;
wherein said first movable platform is translatable in predefined steps along at least one of two orthogonal directions; and
wherein at each said predefined step at least one waveguide cell is positioned to be illuminated by at least one recording beam within said set of recording beams.

2. The holographic recording system of claim 1, further comprising a second movable platform configured to support a second plurality of waveguide cells for exposure, wherein said second movable platform is translatable in predefined steps along at least one of two orthogonal directions.

3. The holographic recording system of claim 1, wherein at least one mirror is disposed along at least one optical path from said at least one laser source to said first movable platform.

4. The holographic recording system of claim 1, wherein at least one beamsplitter is disposed along at least one optical path from said at least one laser source to said first movable platform.

5. The holographic recording system of claim 1, further comprising an optical filter for filtering out ambient light.

6. The holographic recording system of claim 1, further comprising an index matching layer disposed between said master and said waveguide cell.

7. The holographic recording system of claim 1, wherein said set of recording beams comprises at least one zero-order beam and at least one diffracted beam formed by illuminating said at least one master grating.

8. The holographic recording system of claim 1, wherein each of said at least one waveguide cell is illuminated by three sets of recording beams for forming an input grating, a fold grating, and an output grating.

9. The holographic recording system of claim 8, wherein said three sets of recording beams each comprises a zero-order beam and a diffracted beam.

10. The holographic recording system of claim 1, wherein at each said predefined step at least two waveguide cells are positioned such that each waveguide cell can be illuminated by at least one recording beam within said set of recording beams.

11. A method for recording holographic gratings, the method comprising:
providing at least one laser source;
forming a set of recording beams by directing light in a first optical path from said at least one laser source towards at least one master grating;
providing a first movable platform configured to support a first plurality of waveguide cells;
translating said first movable platform to a first operational state so that a first set of waveguide cells within the first plurality of waveguide cells is in position to be illuminated by at least one recording beam from said set of recording beams;
exposing said first set of waveguide cells with said at least one recording beam;
translating said first movable platform so that a second set of waveguide cells within the first plurality of waveguide cells is in position to be illuminated by with said at least one recording beam; and
exposing said second set of waveguide cells with said at least one recording beam.

12. The method of claim 11, wherein exposing said first set of waveguide cells comprises forming a multiplexed grating.

13. The method of claim 11, wherein at least one mirror is disposed along said first optical path.

14. The method of claim 11, wherein at least one beamsplitter is disposed along said first optical path.

15. The method of claim 11, wherein said at least one laser source and said first movable platform is enclosed by an optical filter for filtering out ambient light.

16. The method of claim 11, wherein an index matching layer is disposed between a master grating and at least one waveguide cell within the first plurality of waveguide cells.

17. The method of claim 11, wherein said set of recording beams comprises at least one zero-order beam and at least one diffracted beam formed by illuminating said at least one master grating.

18. The method of claim 11, wherein exposing said first set of waveguide cells comprises simultaneously forming an input grating, a fold grating, and an output grating within each waveguide cell of said first set of waveguide cells.

19. The method of claim 18, wherein each of said input, fold, and output gratings are formed using a single-beam interference exposure process.

20. The method of claim 11, wherein said first set of waveguide cells comprises at least two waveguide cells.
